(19) United States
(12) Patent Application Publication
(10) Pub. No.: US 2008/0077790 A1
(43) Pub. Date: Mar. 27, 2008

(54) AUTHENTICATION SYSTEM USING ELECTRONIC CERTIFICATE

(75) Inventor: Izuru SATO, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 11/829,180

(22) Filed: Jul. 27, 2007

(30) Foreign Application Priority Data
Sep. 22, 2006 (JP) 2006-257287

(51) Int. Cl. H04L 9/00

(52) U.S. Cl. 713/156

(57) ABSTRACT

To speed up a handshake of mutual authentication conforming to a TLS protocol at the time when a session is not established. An authentication method includes notifying, when an electronic certificate of an authentication partner is stored in a storage area of an authentication terminal apparatus, the authentication partner of a possession state of the electronic certificate in a handshake of mutual authentication conforming to a TLS protocol before session establishment; and causing the authentication partner to omit transmission of the electronic certificate.

### BACKGROUND OF THE INVENTION

The present invention relates to an authentication system using an electronic certificate, and more particularly, to an authentication technique using an electronic certificate that enables speeding up of a handshake of mutual authentication conforming to a TLS (Transport Layer Security) protocol when a session is not established between a client serving as an authentication terminal apparatus and a server serving as an authentication processing apparatus.

TLS is a protocol for establishing safe connection between a client and a server via a network. In this TLS, in order to realize the safe connection between the client and the server, it is possible to perform authentication of a partner at a time of start of the connection and exchange a key used for encryption of communication contents.

In a procedure for starting the connection of the TLS, the client and the server can authenticate each other using electronic certificates. When the client and the server authenticate each other according to the TLS, the client and the server transmit their own electronic certificates to each other. In other words, the server transmits a server certificate to the client and the client transmits a client certificate to the server (see Non-Patent document 1).

When the client is requested by the server to transmit the client certificate to the server, the client transmits the client certificate to the server in a format same as that used when the server transmits the server certificate. Therefore, in accordance with a protocol defined in Non-Patent document 1, when mutual authentication is performed, the server certificate and the client certificate are exchanged in the procedure.

There are two methods of reducing a handshake, namely, a method of performing authentication with a common key and a method of performing authentication without transmitting a client certificate (see Non-Patent document 2).

The method of performing authentication with a common key is a method of performing authentication using a shared session key after a client such as a personal computer (PC) and a server perform authentication once. By using this method, transmission and reception of electronic certificates become unnecessary. This method, which is not a method of performing authentication using a public key, can be used only when a session is established in advance (see Patent document 1, Patent document 2, and Non-Patent document 1).

The method of performing authentication without transmitting a client certificate is a method of presenting a URL (Uniform Resource Locator), with which it is possible to acquire the client certificate, to a server and omitting transmission of the client certificate. In Non-Patent document 2, the method of presenting a URL, with which it is possible to acquire the client certificate, instead of the client transmitting the client certificate is defined. Instead of receiving the client certificate from the client, the server acquires the client certificate from a place indicated by the URL. This allows the client to omit transmission of the client certificate.

The TLS is originally a protocol for establishing an encrypted communication path between a client and a server. However, it is possible to use only the part of the handshake of the TLS for authentication between the PC and the server. There is a method of performing authentication by encapsulating a TLS packet according to a protocol called EAP (Extensible Authentication Protocol) (see Non-Patent document 3). This EAP is used as, for example, an authentication protocol in controlling an access of the PC that attempts to make connection to an access point of a Wireless LAN (Wireless Local Area Network) or an Ethernet® switch.

Taking the background art into account, it is earnestly desired to speed up the handshake of mutual authentication conforming to the TLS protocol (sometimes referred to simply as TLS mutual authentication) when a session is not established between the PC and the server. However, it is preferable to realize the method of presenting a client certificate in a URL defined in Non-Patent document 2 without applying the method to a server certificate. This is because, in a case where the method is used for access authentication in EAP-TLS, since transmission and reception of the server certificate are omitted between the PC and the server, the PC cannot access a network to acquire the server certificate.

The following are related arts to the present invention.

### [Patent document 1] Japanese Patent Laid-Open Publication No. 2002-189976 (authentication system and method)

### [Patent document 2] Japanese Patent Laid-Open Publication No. 2000-36809 (Method for Simply Authenticating User and Recording Medium with Its Program Stored therein)

### [Non-Patent document 1] T. Dierks and C. Allen, “The TLS Protocol Version 1.0”, RFC 2246, January 1999

### [Non-Patent document 2] S. Blake-Wilson, M. Nystrom, D. Hopwood, J. Mikkelsen and T. Wright, “Transport Layer Security (TLS) Extensions”, RFC 3546, June 2003

[Non-Patent document 3] B. Aboba, L. Blunk, J. Vollbrecht, J. Carlson and H. Levkowetz, Ed. “Extensible Authentication Protocol (EAP)”, RFC3748, June 2004

### SUMMARY OF THE INVENTION

It is an object of the present invention to provide a technique that enables speeding up of a handshake of mutual authentication conforming to a TLS protocol when a session is not established between an authentication terminal apparatus and an authentication processing apparatus.

To attain the above-mentioned object, according to the present invention, there is provided an authentication method, including: notifying, when an electronic certificate of an authentication partner is stored in a storage area of an authentication terminal apparatus, the authentication partner of a possession state of the electronic certificate in a handshake of mutual authentication conforming to a TLS protocol before session establishment; and causing the authentication partner to omit transmission of the electronic certificate.

In this configuration, when the authentication partner is notified of the possession state of the electronic certificate, information that can identify the electronic certificate owned may be transmitted to allow the authentication partner itself to determine whether transmission of the electronic certificate is to be omitted.

Further, when the electronic certificate is transmitted from the authentication partner that has determined that transmission of the electronic certificate is not to be omitted, and when a procedure for performing mutual authentication is completed, the electronic certificate received through the authentication procedure may be stored in the storage area of the authentication terminal apparatus.

According to the present invention, there is provided a readable medium, which is recorded with a program that causes an authentication terminal apparatus to execute processing of: notifying, when an electronic certificate of an authentication partner is stored in a storage area of the authentication terminal apparatus, the authentication partner of a possession state of the electronic certificate in a handshake of mutual authentication conforming to a TLS (Transport Layer Security) protocol before session establishment; and causing the authentication partner to omit transmission of the electronic certificate.

According to the present invention, there is provided an authentication terminal apparatus, including means for: notifying, when an electronic certificate of an authentication partner is stored in a storage area of the authentication terminal apparatus, the authentication partner of a possession state of the electronic certificate in a handshake of mutual authentication conforming to a TLS protocol before session establishment; and causing the authentication partner to omit transmission of the electronic certificate.

According to the present invention, it is possible to reduce time required for mutual authentication conforming to the TLS protocol.

Other objects, features, and advantages of the present invention will become apparent by reading the specification (embodiment) described below taken in conjunction with the drawings and the scope of claims.

### BRIEF DESCRIPTION OF THE DRAWINGS

FIG. 1 is a diagram showing a procedure at the time when a server certificate owned by a client coincides with a server certificate owned by a server and transmission of the server certificate is omitted in an authentication system according to an embodiment of the present invention;

FIG. 2 is a diagram showing a procedure at the time when a server certificate owned by the client does not coincide with a server certificate owned by the server and the server certificate is transmitted in the authentication system according to the embodiment of the present invention;

FIG. 3 is a diagram showing a procedure of a conventional TLS a handshake;

FIG. 4 is a block diagram showing a detailed structure of the client in the authentication system according to the embodiment of the present invention;

FIG. 5 is a diagram showing an operation procedure of the server in the authentication system according to the embodiment of the present invention;

FIG. 6 is a diagram showing an operation procedure of the client in the authentication system according to the embodiment of the present invention; and

FIG. 7 is a diagram schematically showing an example of a format of a server certificate.

### DETAILED DESCRIPTION OF THE PREFERRED EMBODIMENTS

The present invention will hereinafter be explained more in detail with reference to the accompanying drawings. Preferred embodiments of the present invention are shown in the drawings. However, it is possible to carry out the present invention in many different forms. The present invention should not be interpreted as being limited to the embodiments described in this specification. Rather, these embodiments are provided to make the disclosure of this specification thorough and complete and to fully inform those skilled in the art of the scope of the present invention.

### [Structure of an Authentication System]

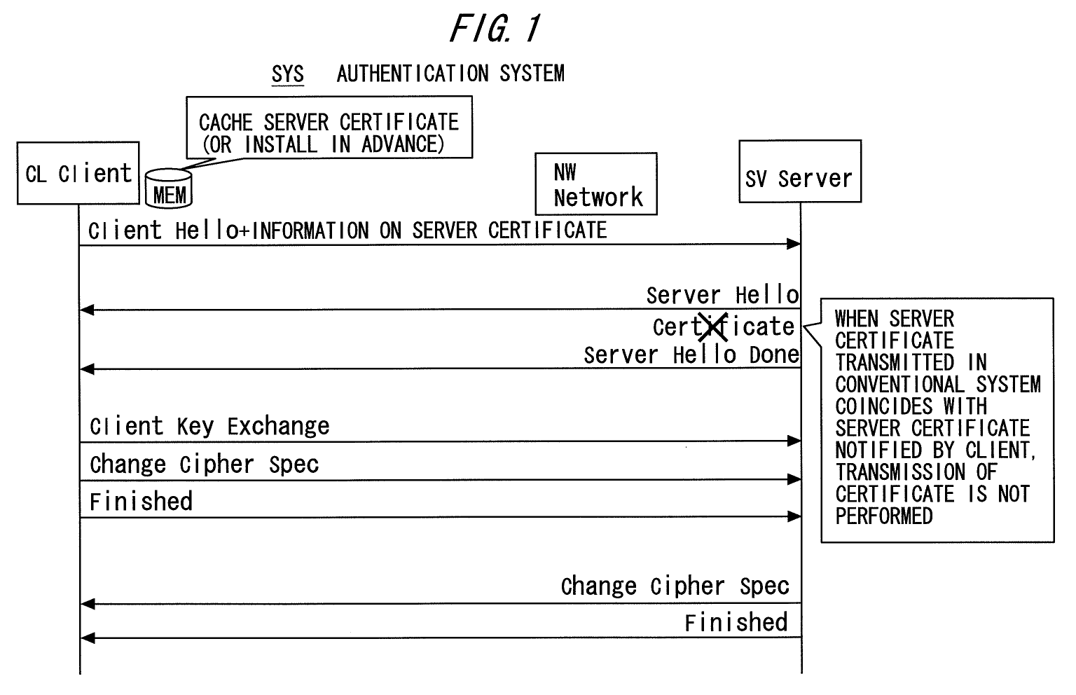

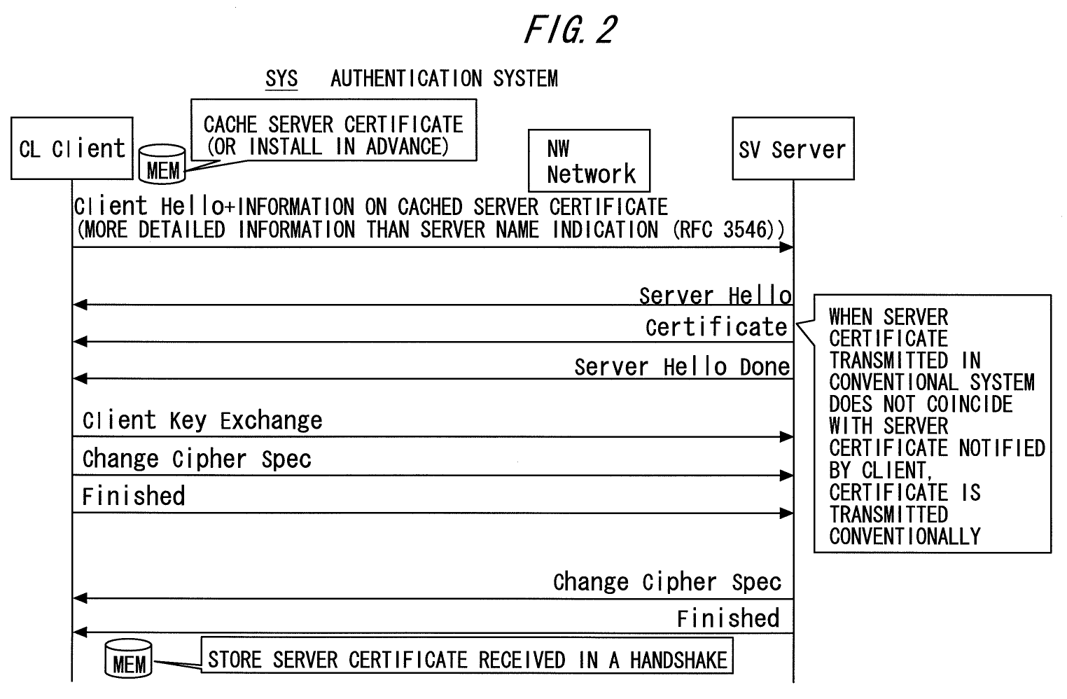

As shown in FIGS. 1 and 2, an authentication system SYS using an electronic certificate according to an embodiment of the present invention includes a server SV serving as an authentication processing apparatus, a client CL serving as an authentication terminal apparatus, and a network NW that connects the server SV and the client CL.

The server (server computer) SV is a personal computer and includes a central processing unit, a main storage device, a hard disk drive device serving as an auxiliary storage device, and a communication interface. However, illustration of a detailed structure of the server SV is omitted here.

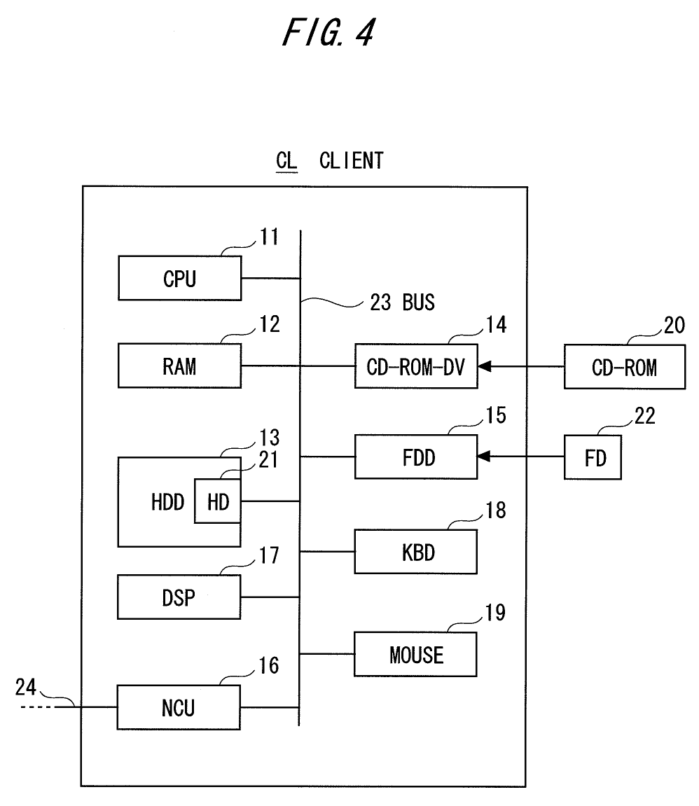

It is possible to realize the client (client terminal apparatus) CL with a personal computer. The client CL includes a central processing unit, a main storage device, a hard disk drive device serving as an auxiliary storage device, a display device serving as a display, a keyboard and a mouse serving as input devices, and a communication interface. A detailed structure of the client CL will be explained later with reference to FIG. 4. The client CL may be a cellular phone terminal having the same components.

It is possible to constitute the network NW with a communication network such as the Internet or an intranet. In the server SV and the client CL, in logically realizing a processing function for an authentication procedure conforming to the TLS protocol described in detail later, the processing function is installed as an application program (TLS authentication processing program) in the auxiliary storage devices (hard disk drives) or the like of the server SV and the client CL.

### (Detailed Structure of the Client)

Referring to FIG. 4 showing a detailed structure of the client CL, when the client CL is constituted by a personal computer, the client CL includes a central processing unit (CPU) 11, a main storage device (RAM) 12, a hard disk drive device (HDD) 13, a CD-ROM drive device (CD-ROM-DV) 14, a flexible disk drive device (FDD) 15, and a communication control device (NCU) 16.

A display device (DSP) 17 is connected to the client CL via a graphic board (not shown). In addition, a keyboard 18 (KBD) and a mouse 19 serving as input devices are connected to the client CL via predetermined interfaces, respectively. These components are connected to one another through a bus 23.

In the main storage device 12, a TLS authentication processing program (TLS client program) that controls the client CL is expanded from a hard disk (HD) 21. A storage area of the main storage device 12 is used for holding a result of processing by this program and temporary data for the processing.

The hard disk drive device 13 and the flexible disk drive device 15 serving as auxiliary (external) storage devices store programs and control data in the hard disk 21 and a flexible disk (FD) 22 serving as recording media corresponding to the drive devices, respectively. The CD-ROM drive device 14 serving as an auxiliary storage device is used for reading a program and data stored in a CD-ROM 20.

The communication control device 16 is constituted by a network card, a modem, and the like. The communication control device 16 is used for performing transmission and reception of data (various messages) to and from the server SV and download of programs from other apparatuses, via a network communication line 24.

The keyboard 18 includes a plurality of keys and is used for performing input of various kinds of data. The mouse 19 is used for an operation of a mouse cursor displayed on a screen of the display device 17 and an operation of selection and indication (designation) by the mouse cursor.

The TLS client program that causes the client CL to execute the processing of the present invention is stored in the hard disk 21 of the hard disk drive device 13 in advance from the CD-ROM 20 or the flexible disk 22, which is a portable medium, by the CD-ROM drive device 14 or the flexible disk drive device 15. This program may be stored in the hard disk 21 by the communication control device 16 via the network NW.

The TLS client program is loaded to the main storage device 12 from the hard disk 21 according to a predetermined designation operation by a user who uses the client CL. The TLS client program controls the respective units of the client CL to perform the processing of the present invention.

### [Operation of the Authentication System]

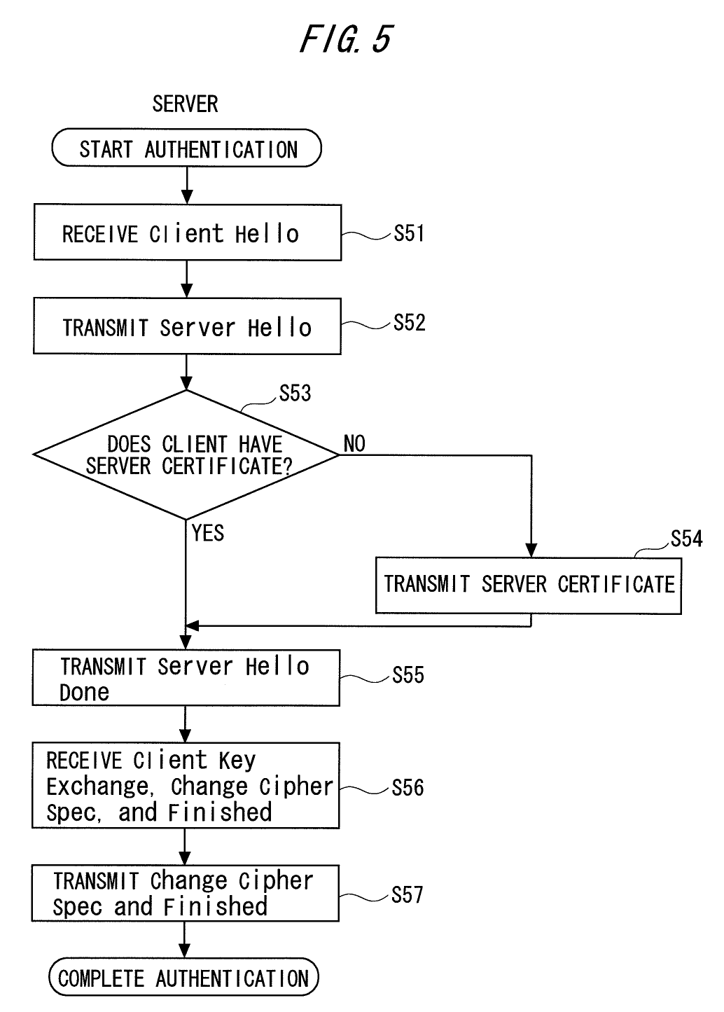

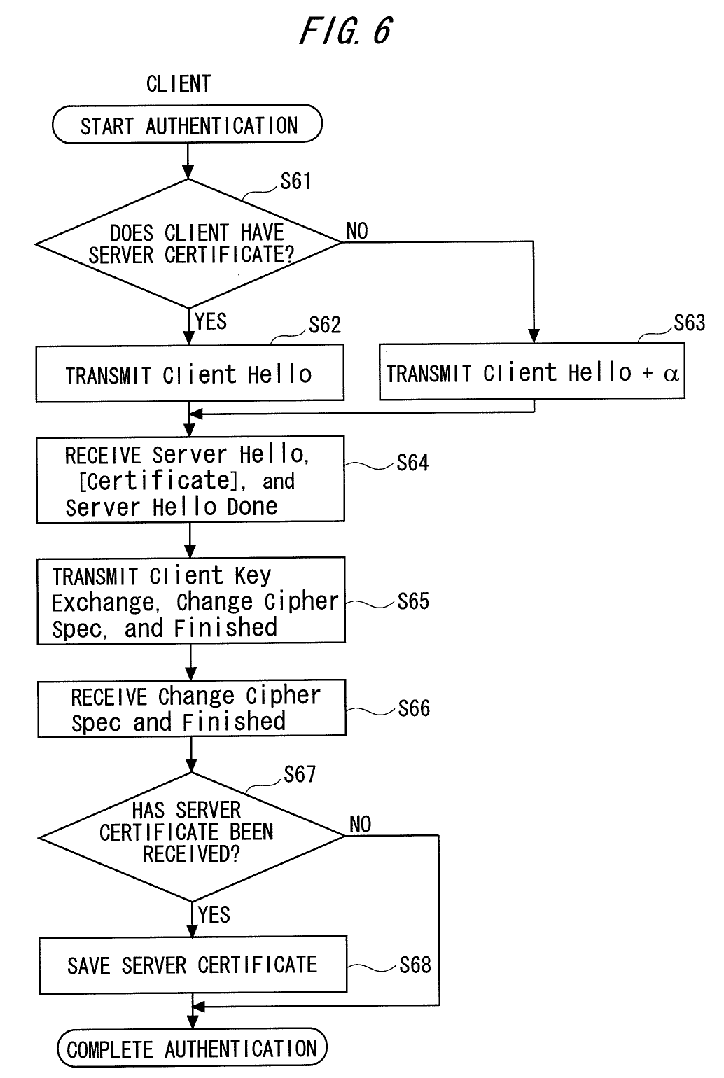

An example of an operation in the authentication system SYS using an electronic certificate according to the embodiment of the present invention will be explained next with reference to FIGS. 1 to 7. In the following explanation of the operation, the intervention of the network NW is omitted.

In this authentication system SYS using an electronic certificate, as authentication preparation processing, the server certificate is stored in a storage area MEM (hard disk 21) of the client CL. If a handshake such as access authentication is always performed with the same server, a server certificate transmitted at the time of authentication is usually the same every time authentication is performed. Therefore, the server certificate is stored in the storage area MEM of the client CL by some method in advance. For example, when the client CL is a personal computer, it is possible to copy the server certificate from a portable medium such as the flexible disk 22 at the time of setting an authentication client. When access authentication for a cellular phone terminal serving as the client CL is assumed, it is possible to store information in an SIM (Subscriber Identity Module) card.

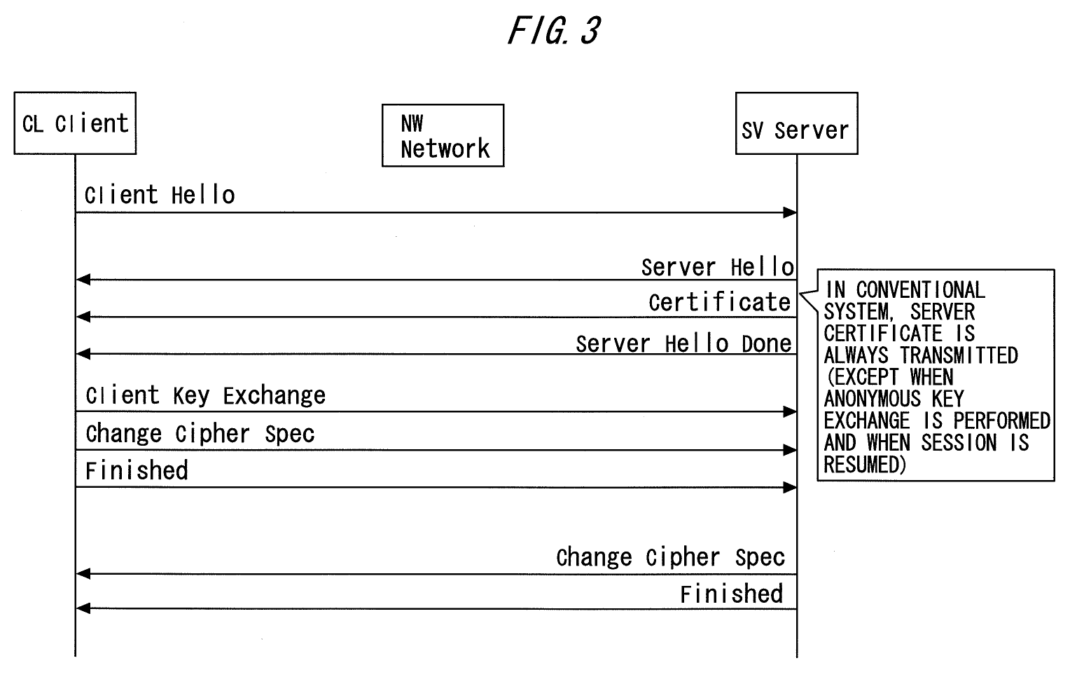

In the client CL, when a handshake is performed in a similar manner as that in the past at the time of authentication, since the server certificate is transmitted from the server SV, it is also possible that the server certificate is not stored at first but is received by a hand shake according to the conventional procedure and stored (cached). The handshake of the TLS according to the conventional procedure is performed as shown in FIG. 3 (see FIG. 1 of Non-Patent document 1).

In the client CL, when it is judged by the central processing unit 11, which cooperates with the TLS client program, that the client CL has the server certificate, the client CL notifies an encryption algorithm and the like that the client CL can use and notifies (transmits) a random number value required for key exchange to the server SV with a Client Hello message. When the client CL transmits the Client Hello message, the client CL adds a value (possession information) indicating that the client CL has the server certificate to the message and transmits the message to the server SV (S61 and S63).

To indicate to the server SV that the client CL has the server certificate, in addition to a method of transmitting a flag for instructing to control the transmission, it is also possible to transmit information with which specifying of the server certificate such as an issuer (owner) of the server certificate, a serial number of the certificate, and a hash value of the server certificate becomes possible. In this case, on the server SV side, the central processing unit can check, on the basis of the TLS authentication processing program, whether the server certificate held by the client CL coincides with a server certificate held by the server SV.

The server SV, which has received this Client Hello message, transmits the encryption algorithm and the like agreed to by the server SV and the random number value required for key exchange to the client CL with a Server Hello message (S51, S52, and S64).

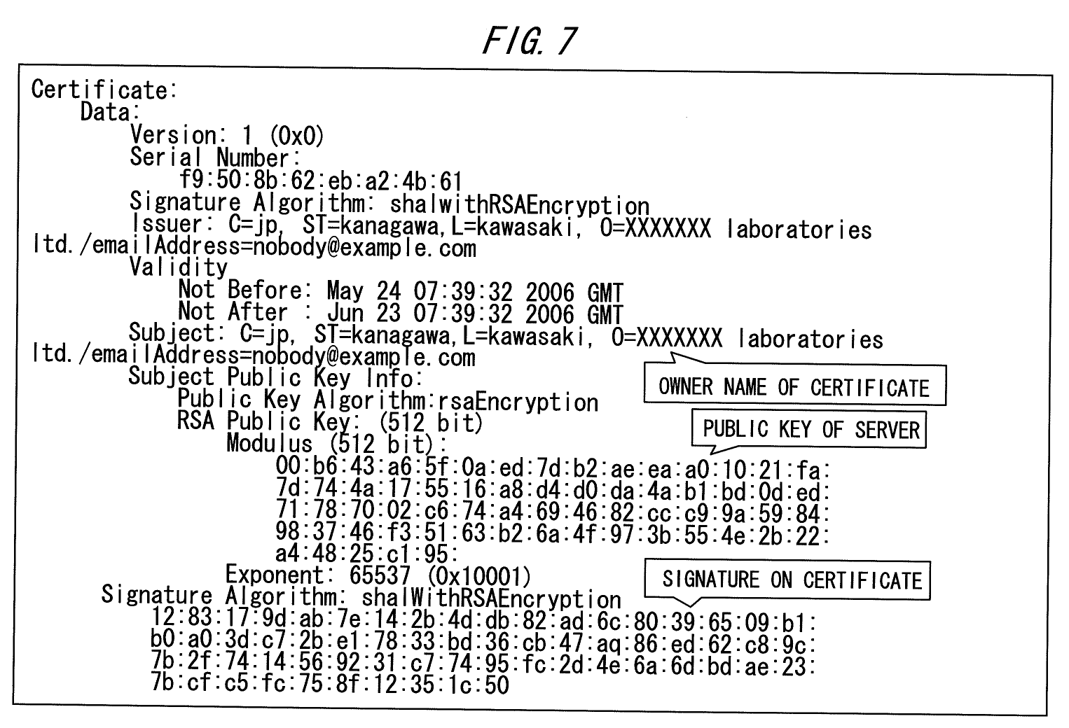

When the server SV is not notified by the Client Hello message that the client CL has the server certificate, the server SV transmits a server certificate (see FIG. 7) to the client CL with a Server Certificate message. When the server SV judges according to the Client Hello message received from the client CL that the client CL already has the server certificate and it is possible to omit transmission of the server certificate, the server SV omits transmission of the certificate. When the notification from the client CL is notification by a flag, the server SV determines omission of transmission according to a presence or absence of the flag. When the client CL transmits information for specifying a server certificate to the server SV, after checking whether the server certificate coincide with the server certificate held by the server SV, the server SV determines necessity of transmission of the certificate (S53, S54, S62, and S64).

Consequently, when the client CL owns a wrong server certificate, it is possible to prevent the server SV from simply causing the client CL to fail in authentication and perform authentication by the conventional procedure from the beginning again.

When transmission of the server certificate is necessary, the server SV transmits the server certificate to the client CL with a Server Certificate message. In this case, since the server certificate is transmitted, an operation is the same as that of an authentication procedure conforming to the conventional TLS protocol (may simply be referred to as TLS authentication procedure).

After the procedure described above, the server SV transmits a Server Hello Done message to the client CL and notifies the client CL that data transmission from the server SV has been finished (S55).

When the client CL receives this message, the client CL transmits a key to the server SV with a Client Key Exchange message (S64 and S65). A specific meaning of this message depends on the encryption algorithm.

The client CL further transmits a Change Cipher Spec message to the server SV and notifies the server SV that messages to be transmitted from the client CL to the server SV after that are to be encrypted (S65).

After transmitting the Change Cipher Spec message, the client CL transmits a Finished message to the server SV and notifies that the authentication procedure has been completed (S65). It should be noted that this message is encrypted because the message is transmitted after the Change Cipher Spec message.

The server SV, which has received the Client Key Exchange message, the Change Cipher Spec message, and the Finished message transmitted from the client CL, transmits a Finished message to the client CL subsequent to the Change Cipher Spec message and notifies the client CL of completion of the authentication procedure (S56, S57, and S66).

According to the procedure described above, the server SV and the client CL agree upon encrypted communication and a session is established therebetween. Thus, it becomes possible to encrypt application data to perform transmission and reception of the data between the server SV and the client CL. When the client CL receives the server certificate from the server SV through the authentication procedure described above, in order to use the server certificate at the time of the next authentication, the client CL saves the server certificate in the storage area MEM as a file (S67 and S68).

Giving supplementary explanation about a difference between the authentication procedure of the authentication system SYS using an electronic certificate and the conventional TLS authentication procedure, when both the client CL and the server SV communicating with each other via the network NW are personal computers, the client CL includes a file system and can save the server certificate as a file.

Before starting TLS authentication, the user who operates the client CL copies the server certificate to the hard disk 21 of the client CL using a portable medium or the like and causes the TLS authentication processing program (TLS client program) to recognize a file name of the server certificate.

The TLS client program provided in the client CL is transmitted to the server SV with a hash value of the server certificate included therein at the time when the Client Hello message is transmitted. The server SV, which has received this hash value, compares the hash value with a hash value of a server certificate that is originally planned to be transmitted by the server SV.

When the hash values coincide with each other, the server SV omits transmission of the server certificate to the client CL by the Server certificate message. When the hash values do not coincide with each other, the server SV operates assuming that the possession information of the Client Hello message is not present and transmits the server certificate in accordance with the conventional TLS authentication procedure. Procedures after that are the same as those in the conventional TLS a handshake except the presence or absence of certificate transmission.

When the server certificate is transmitted from the server SV to the client CL, the client CL writes the received server certificate in a file when the handshake is successful. Consequently, it is possible to use this server certificate in the next and subsequent authentications.

### EFFECTS OF THE EMBODIMENTS

As described above, according to the authentication system using an electronic certificate according to the embodiment of the present invention, it is possible to omit transmission of the electronic certificate. In other words, it is possible to omit a transmission message portion (e.g., 1 kilobyte) of the electronic certificate corresponding to a portion with a large data amount (number of bytes) in a plurality of messages transmitted and received in the authentication procedure conforming to the TLS protocol. Thus, it is possible to reduce time required for transmission and reception of messages (packets) between the client and the server. As a result, it is possible to reduce time required for mutual authentication conforming to the TLS protocol.

According to this authentication system, compatibility with the conventional technique (authentication procedure conforming to the conventional TLS protocol) is kept. In other words, even when one of the client and the server does not adopt the technique of the present invention (authentication procedure conforming to the improved TLS protocol), it is possible to normally complete authentication itself by performing mutual authentication according to the authentication procedure conforming to the conventional TLS protocol. In this case, although speed-up of authentication by the improved authentication procedure, which is the original effect, cannot be realized, an effect in which normal mutual authentication is performed in an environment in which software implemented with the improved authentication processing and software not implemented with the improved authentication processing are mixed can be obtained.

The disclosure of Japanese Patent Application No. JP2006-257287 filed on Sep. 22, 2006 including the specification, claims, drawings and abstract is incorporated herein by reference in its entirety.

What is claimed is:

1. An authentication method, comprising:
notifying, when an electronic certificate of an authentication partner is stored in a storage area of an authentication terminal apparatus, the authentication partner of a possession state of the electronic certificate in a handshake of mutual authentication conforming to a TLS (Transport Layer Security) protocol before session establishment; and
causing the authentication partner to omit transmission of the electronic certificate.

2. An authentication method according to claim 1, further comprising:
transmitting, in notifying the authentication partner of the possession state of the electronic certificate, information that can identify the electronic certificate owned to allow the authentication partner itself to determine whether transmission of the electronic certificate is to be omitted.

3. An authentication method according to claim 2, further comprising:
storing, when the electronic certificate is transmitted from the authentication partner that has determined that transmission of the electronic certificate is not to be omitted, and when a procedure for performing mutual authentication is completed, the electronic certificate received through the authentication procedure in the storage area of the authentication terminal apparatus.

4. A readable medium, which is recorded with a program that causes an authentication terminal apparatus to execute processing of:
notifying, when an electronic certificate of an authentication partner is stored in a storage area of the authentication terminal apparatus, the authentication partner of a possession state of the electronic certificate in a handshake of mutual authentication conforming to a TLS (Transport Layer Security) protocol before session establishment; and
causing the authentication partner to omit transmission of the electronic certificate.

5. A readable medium according to claim 4, which is recorded with a program that causes the authentication terminal apparatus to further execute processing of:
transmitting, in notifying the authentication partner of the possession state of the electronic certificate, information that can identify the electronic certificate owned to allow the authentication partner itself to determine whether transmission of the electronic certificate is to be omitted.

6. A readable medium according to claim 5, which is recorded with a program that causes the authentication terminal apparatus to further execute processing of:
storing, when the electronic certificate is transmitted from the authentication partner that has determined that transmission of the electronic certificate is not to be omitted, and when a procedure for performing mutual authentication is completed, the electronic certificate received through the authentication procedure in the storage area of the authentication terminal apparatus.

7. An authentication terminal apparatus, comprising:
means for notifying, when an electronic certificate of an authentication partner is stored in a storage area of the authentication terminal apparatus, the authentication partner of a possession state of the electronic certificate in a handshake of mutual authentication conforming to a TLS (Transport Layer Security) protocol before session establishment; and
means for causing the authentication partner to omit transmission of the electronic certificate.

8. An authentication terminal apparatus according to claim 7, further comprising:
means for transmitting, in notifying the authentication partner of the possession state of the electronic certificate, information that can identify the electronic certificate owned to allow the authentication partner itself to determine whether transmission of the electronic certificate is to be omitted.

9. An authentication terminal apparatus according to claim 8, further comprising:
means for storing, when the electronic certificate is transmitted from the authentication partner that has determined that transmission of the electronic certificate is not to be omitted, and when a procedure for performing mutual authentication is completed, the electronic certificate received through the authentication procedure in the storage area of the authentication terminal apparatus.
